(19) United States
(12) Patent Application Publication
(10) Pub. No.: US 2025/0328380 A1
(43) Pub. Date: Oct. 23, 2025

(54) TECHNIQUES FOR PERFORMING DATA OPERATIONS USING A DATA BRIDGE

(71) Applicant: NETFLIX, INC., Los Gatos, CA (US)

(72) Inventors: Vladyslav SYDORENKO, Seattle, WA (US); Puneet ZAROO, Los Gatos, CA (US); Leandro TAVERAS, New York, NY (US); Emmie DONG, San Jose, CA (US); Kasturi CHATTERJEE, Redwood City, CA (US)

(21) Appl. No.: 19/097,778

(22) Filed: Apr. 1, 2025

Related U.S. Application Data
(60) Provisional application No. 63/635,999, filed on Apr. 18, 2024.

(51) Int. Cl. G06F 9/48; G06F 9/445

(52) U.S. Cl. CPC G06F 9/4881; G06F 9/44505; G06F 2209/486

(57) ABSTRACT

One embodiment sets forth a technique for setting up and implementing one or more data connectors. According to some embodiments, the technique can include the steps of receiving a request to register a data connector with a data bridge, validating that the data connector is associated with a first datastore and a second datastore that are both registered with the data bridge, validating a plurality of parameters associated with the data connector, registering the data connector with the data bridge, and generating an interface associated with the data connector, wherein the interface includes at least one function for receiving a plurality of values for the plurality of parameters to perform at least one data operation on a first dataset. Another embodiment sets forth techniques for performing operations on datasets via a data bridge.

### CROSS-REFERENCE TO RELATED APPLICATIONS

The present application claims the benefit of U.S. Provisional Application titled, “TECHNIQUES FOR ACCESSING AND TRANSMITTING DISPARATE DATA USING A DATA BRIDGE”, filed on Apr. 18, 2024, and having Ser. No. 63/635,999. The subject matter of this related application is hereby incorporated herein by reference.

### BACKGROUND

### Field of the Various Embodiments

Embodiments of the present disclosure relate generally to computer science and computer networks, and more specifically, to techniques for performing data operations using a data bridge.

### Description of the Related Art

Many organizations rely heavily on data to support a wide range of operations, analyses, and decision-making processes. Data beneficially enables organizations to gain valuable insights, improve workflows, and achieve strategic objectives. However, organizing and utilizing data effectively is complex, as the data is often stored across various datasets and datastores, and is accessed by different groups for diverse purposes and applications. These complexities create significant inefficiencies for organizations, including difficulties in effectively carrying out data sharing, integration, and analysis. For example, data stored in incompatible formats often requires manual processes to transform datasets into compatible formats, which can introduce inefficiencies and errors during conversion. Moreover, identifying whether a tool for converting a given dataset to a different format is available, let alone understanding how to effectively access and utilize the tool, can be quite difficult for a given employee or group. These inefficiencies are further exacerbated by inherent difficulties in effectively securing the data, tracking the usage of the data, and tracking the ownership of the data.

One drawback of conventional approaches for organizing data involves the complexities of data migration between systems. Migration processes typically require extensive mapping between source and destination data structures, which constitutes a task that becomes more intricate when dealing with legacy systems or specialized databases. Standard migration tools often fail to address edge cases, such as handling hierarchical data, embedded metadata, or encrypted fields, thereby necessitating manual intervention and increasing the likelihood of errors, inconsistencies, and data losses. System downtime during migrations can further disrupt operations, particularly when the data being migrated is actively used by multiple groups.

Yet another drawback of conventional approaches for organizing data arises from the difficulties in tracking data ownership as data moves between groups or systems. Without centralized tracking mechanisms, determining ownership for data at any given point in the data lifecycle can become difficult, if not impossible. This lack of ownership visibility can lead to conflicts over data modifications, data usage rights, and data retention policies, all of which are especially problematic in collaborative environments. Furthermore, traditional tracking systems usually are not capable of accounting for the complex relationships between derived datasets and the original data sources, which creates additional inefficiencies and vulnerabilities in scenarios and applications where clear data ownership and data accountability are important.

As the foregoing illustrates, what is needed in the art are more effective techniques for organizing datasets.

### SUMMARY

One embodiment sets forth a computer-implemented method for setting up and implementing one or more data connectors. According to some embodiments, the method includes the steps of receiving a request to register a data connector with a data bridge, validating that the data connector is associated with a first datastore and a second datastore that are both registered with the data bridge, validating a plurality of parameters associated with the data connector, registering the data connector with the data bridge, and generating an interface associated with the data connector, wherein the interface includes at least one function for receiving a plurality of values for the plurality of parameters to perform at least one data operation on a first dataset.

Another embodiment sets forth a computer-implemented method for performing operations on datasets via a data bridge. According to some embodiments, the method includes the steps of receiving a request to perform at least one data operation on a first dataset, identifying, based on the request, a data connector that is associated with a plurality of parameters and through which at least one data operation is to be performed on the first dataset, receiving a plurality of values for the plurality of parameters, validating the plurality of values based on validation logic associated with the data connector, and generating a data task that, when executed, causes an instance of the data connector to perform the at least one data operation on the first dataset in accordance with the plurality of values.

Other embodiments of the present disclosure include, without limitation, one or more computer-readable media including instructions for performing one or more aspects of the disclosed techniques as well as a computing device for performing one or more aspects of the disclosed techniques.

One technical advantage of the disclosed techniques relative to the prior art is that the disclosed techniques centralize data operations across disparate systems through the use of a data bridge. By acting as a unified coordination point, the data bridge can simplify the flow of data between different systems as well as provide improved error handling and logging capabilities that help identify and address issues that arise when performing data operations. The data bridge includes a registration process that allows developers to contribute data connectors that are designed to handle specific data operations, such as data migrations, with logic tailored to different dataset and datastore types. The modular and scalable framework supports the integration of migration capabilities without requiring extensive redevelopment for each new system or use case. The data bridge also can simplify data migration workflows by allowing users to specify the type of data migration operations to be performed through easy-to-use interfaces. In this regard, the data bridge can identify the appropriate connector for a given data migration task to align the migration logic with the specific requirements of the data migration task. This automated identification can help avoid technical errors that oftentimes occur with conventional, manual approaches, particularly in environments with numerous systems and diverse datasets. Additionally, the data bridge includes scheduling (e.g., predefined times) and conditional execution (e.g., predefined criteria) features that can provide flexibility in performing data operations. These technical advantages provide one or more technological advancements over prior art approaches.

### BRIEF DESCRIPTION OF THE DRAWINGS

So that the manner in which the above recited features of the various embodiments can be understood in detail, a more particular description of the inventive concepts, briefly summarized above, may be had by reference to various embodiments, some of which are illustrated in the appended drawings. It is to be noted, however, that the appended drawings illustrate only typical embodiments of the inventive concepts and are therefore not to be considered limiting of scope in any way, and that there are other equally effective embodiments.

FIG. 1 illustrates a network infrastructure configured to implement one or more aspects of the various embodiments.

FIG. 2 is a more detailed illustration of the data bridge of FIG. 1, according to various embodiments.

FIG. 3 sets forth a flow diagram of method steps for setting up and implementing one or more data connectors, according to various embodiments.

FIG. 4 sets forth a flow diagram of method steps for performing operations on one or more datasets via a data bridge, according to various embodiments.

FIG. 5 is a conceptual illustration of a computing device that can be used to implement any of the computing devices shown in FIG. 1, according to various embodiments.

### DETAILED DESCRIPTION

In the following description, numerous specific details are set forth to provide a more thorough understanding of the various embodiments. However, it will be apparent to one skilled in the art that the inventive concepts may be practiced without one or more of these specific details.

As described, many organizations rely heavily on data to support a wide range of operations, analyses, and decision-making processes. However, effectively organizing and utilizing data is challenging because data is often distributed across diverse datasets and datastores, and accessed by various groups for different purposes. These challenges can create inefficiencies in data sharing, integration, and analysis, as data stored in incompatible formats often requires manual transformation into compatible formats, which can lead to errors and inefficiencies. Data migration processes also present significant drawbacks, as such processes typically involve extensive mapping between source and destination structures, and standard tools often fail to address edge cases such as hierarchical data, embedded metadata, or encrypted fields. These limitations frequently require manual intervention, which increases the likelihood of errors, inconsistencies, and data loss. Furthermore, tracking data ownership across groups or systems is difficult without centralized mechanisms, and can lead to conflicts over modifications, usage rights, and retention policies. Moreover, traditional tracking systems are often unable to account for relationships between derived datasets and their original sources, which increases inefficiencies and creates vulnerabilities in managing data ownership and accountability.

The disclosed techniques set forth a comprehensive system for performing data operations across datasets managed by one or more datastores through the use of data connectors. At the core of the system is a data bridge, which sits above and manages the data connectors, a data scheduler, one or more data connector engines, and a registry, which are used to facilitate seamless orchestration and control of the data connectors. The data bridge enables developers to submit, for registration with the data bridge, data connectors that are configured to perform specific data operations on one or more datasets stored in one or more datastores. A given data connector includes data operation logic, which defines different data operations to be performed, and validation logic, which ensures the accuracy, consistency, and security of provided parameters that configure the data connector for execution. A data task is generated when a user requests the use of a data connector, and the data task encapsulates key components such as parameters (e, source and destination dataset references, configuration settings, mapping details, etc.), condition information (eq., timing schedules or event-based triggers), security information (e, credentials for accessing datastores and datasets), and ownership information (e, identifying the user associated with the task). When a trigger for executing a given data task occurs, the data bridge interfaces with a data connector engine to invoke the corresponding data connector under a configuration that is consistent with the various parameters stored in the data task. Additionally, the scheduling manager interacts with a registry to generate data task information, which can be used to monitor, track, and log the status and execution details of current or completed data tasks.

One technical advantage of the disclosed techniques relative to the prior art is that the disclosed techniques centralize data operations across disparate systems through the use of a data bridge. By acting as a unified coordination point, the data bridge can simplify the flow of data between different systems as well as provide improved error handling and logging capabilities that help identify and address issues that arise when performing data operations. The data bridge includes a registration process that allows developers to contribute data connectors that are designed to handle specific data operations, such as data migrations, with logic tailored to different dataset and datastore types. The modular and scalable framework supports the integration of migration capabilities without requiring extensive redevelopment for each new system or use case. The data bridge also can simplify data migration workflows by allowing users to specify the type of data migration operations to be performed through easy-to-use interfaces. In this regard, the data bridge can identify the appropriate connector for a given data migration task to align the migration logic with the specific requirements of the data migration task. This automated identification can help avoid technical errors that oftentimes occur with conventional, manual approaches, particularly in environments with numerous systems and diverse datasets. Additionally, the data bridge includes scheduling (e.g., predefined times) and conditional execution (e.g., predefined criteria) features that can provide flexibility in performing data operations.

### System Overview

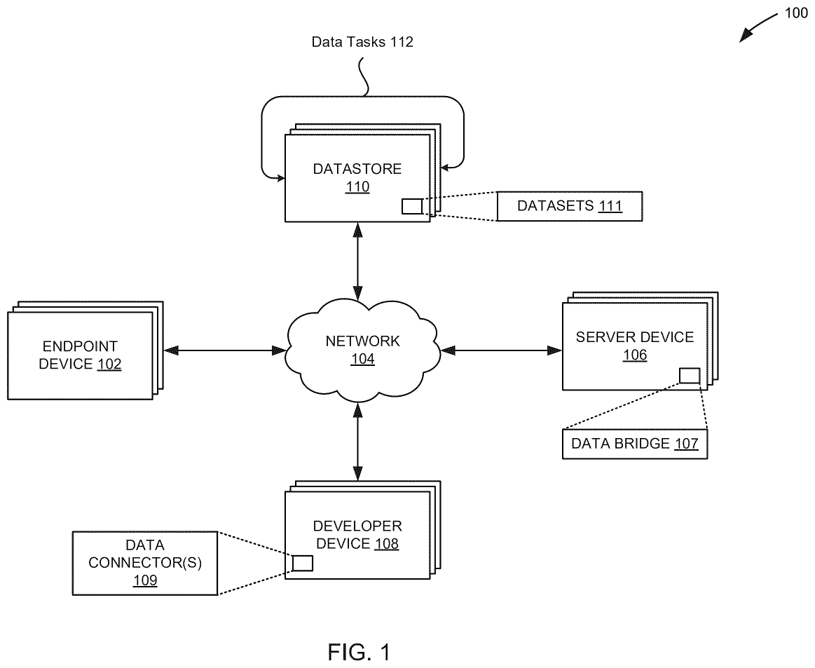

FIG. 1 illustrates a network infrastructure 100 configured to implement one or more aspects of the various embodiments. As shown, the network infrastructure 100 can include at least endpoint device 102, at least one server device 106, at least one developer device 108, and at least one datastore 110, each of which can be connected via a communications network 104. The communications network 104 can represent, for example, any technically feasible network or number of networks, including a wide area network (WAN) such as the Internet, a local area network (LAN), a Wi-Fi network, a cellular network, or a combination thereof.

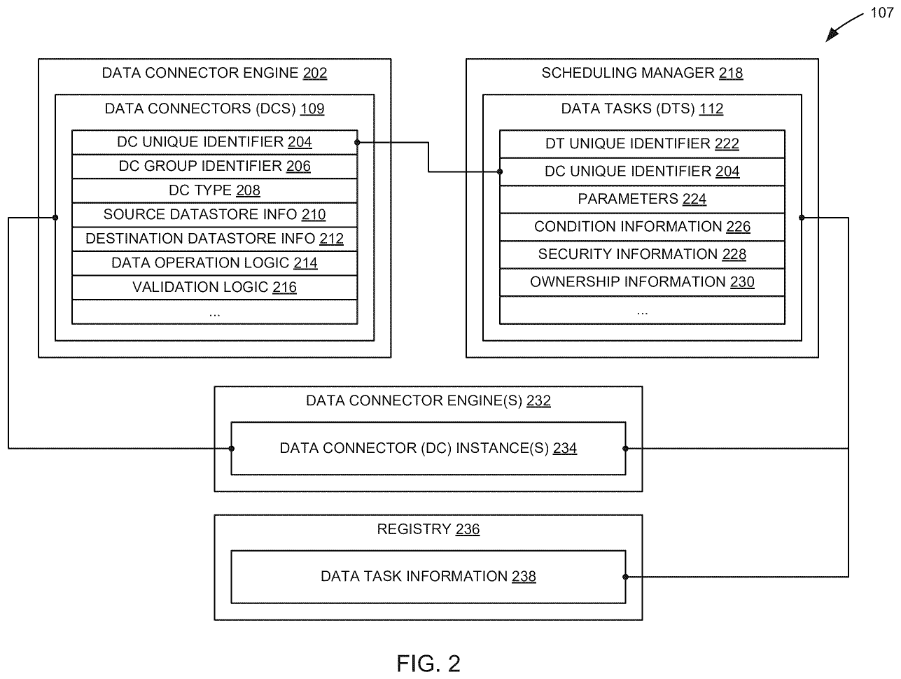

The server devices 106 can represent one or more computing devices, such as rack servers, blade servers, tower servers, microservers, hyper-converged infrastructure servers, mainframe servers, etc., that are implemented by, accessible to, etc., an organization. The server devices 106, collectively referred to hereinafter as the server device 106, can be configured to implement a data bridge 107 for centralizing and orchestrating the manner in which data operations are carried out within the organization. According to some embodiments, software developers can write, produce, etc., data connectors 109 that are configured to perform specialized data operations (illustrated in FIG. 1 as data tasks 112) on datasets 111 that are managed by datastores 110. The developers can then provide, e.g., via the developer devices 108, the data connectors 109 to the data bridge 107 for registration. Upon receipt of a data connector, the data bridge 107 can verify that the data connector satisfies different requirements that are imposed by the data bridge 107. When one or data connectors have been registered with the data bridge 107, users operating the endpoint devices 102 can interact with the data bridge 107 to invoke the data operations that are available through the data connectors 109. A more detailed explanation of the architecture of the data bridge 107, as well as the functionalities implemented by the data bridge 107, is provided below in conjunction with FIGS. 2-4.

A given datastore 110 can represent any computer, service, entity, etc., that enables datasets 111 to be created, managed, and accessed. For example, the datastore 110 can represent a distributed database that is optimized for high availability and scalability, a relational database system that is designed for structured data, a spreadsheet service, word processing service, presentation service, etc., that is accessible through a web-based interface, or a search platform capable of indexing and retrieving volumes of data. The datastore 110 can also represent a stream processing system configured to manage real-time data flows, an object storage service configured to implement scalable data storage and retrieval, or a platform that maintains immutable datasets for consistent access across distributed systems. It is noted that the foregoing examples are not meant to be limiting, and that the datastore 110 can manage any number, type, form, etc., of dataset(s) 111, at any level of granularity, consistent with the scope of this disclosure.

A given developer device 108, as well as a given endpoint device 102, can represent any computing device configured to interact with the server device 106 to access services provided by the data bridge 107. Examples of such computing devices include smartphones, tablets, desktop computers, and laptops. It is noted that the foregoing examples are not meant to be limiting, and that the developer devices 108 and the endpoint devices 102 can represent any number, type, form, etc., of computing device(s), consistent with the scope of this disclosure.

### Data Bridge Architecture

FIG. 2 is a more detailed illustration of the data bridge 107 of FIG. 1, according to various embodiments. As shown, the data bridge 107 can implement a data connector manager 202, a scheduling manager 218, one or more connector engines 232, and a registry 236. According to some embodiments, the data connector manager 202 can be configured to manage one or more data connectors 109, where each data connector 109 is configured to perform data operations on one or more datasets 111. As shown, a given data connector 109 can include a unique identifier 204 for uniquely identifying the data connector 109 relative to other data connectors 109. The data connector 109 can also include a unique identifier 206 for assigning the data connector 109 to a given group of data connectors 109 (i.e., where all data connectors 109 in the group share the same unique identifier 206 to effectively assign the data connectors 109 to the group). In this manner, different data connectors 109 can be organized into different groups, which can enable administrators, users, etc., to access the data connectors 109 in a more organized, hierarchical, etc., manner. It should be appreciated that additional group identifiers can be assigned to the data connectors 109 so that additional layers of groupings can be effected, consistent with the scope of this disclosure.

According to some embodiments, and, as shown, the data connector 109 can include a data connector type 208, which designates the operational mode of the data connector 109. In one example, the data connector 109 can be implemented as a streaming connector that processes data in real time and is designed to handle potentially unbounded datasets. Such streaming connectors can operate as long-running processes, and can be configured to continuously ingest and process new data as the data arrives. An example of data suitable for a streaming connector includes Change Data Capture (CDC) events, where data updates are processed quickly to maintain system responsiveness. In another example, the data connector 109 can be implemented as a batch connector that processes data in discrete/bounded sets. Such batch connectors can operate on scheduled bases, conditional bases, ad hoc bases, etc., and can be configured to execute tasks that begin with data ingestion and end upon completion of processing. In another example, the data connector 109 can be implemented as a triggered connector that begins operations in response to specific events such as file uploads or threshold breaches, thereby enabling dynamic, event-driven workflows. In another example, the data connector 109 can be implemented as a continuous query connector that continuously applies predefined queries to streaming data to produce immediate results for real-time analytics or monitoring. In yet another example, the data connector 109 can be implemented as an interactive connector that processes data on demand in response to user queries or ad hoc instructions, thereby providing near-instant results. It is noted that the foregoing examples are not meant to be limiting, and that the data connector 109 can be configured to implement any type any amount, type, form, etc., of operational modes, at any level of granularity, consistent with the scope of this disclosure.

According to some embodiments, and, as shown, the data connector 109 can include source datastore information 210 that corresponds to a datastore 110. The source datastore information 210 can include information that enables the data connector 109 to programmatically connect to and interact with the corresponding datastore 110. The information can include connection details such as the network address, port, and protocol required to establish communication with the datastore 110. The information can also include parameters for authentication credentials, such as usernames, passwords, API keys, token-based access configurations, etc., to gain access to and communicate with the datastore 110. The information can also include metadata that describes the structure of the source datastore 110, such as schema definitions, table names, field names, or data types, which can be used to facilitate the accurate querying and retrieval of data. Additionally, the information can include configuration parameters, such as query preferences, access permissions, timeout settings, etc., so that the data connector 109 can be fine-tuned to interact with the datastore 110 in a manner that addresses specific operational needs. It is noted that the foregoing examples are not meant to be limiting, and that source datastore information 210 can include any amount, type, form, etc., of information, at any level of granularity, to effectively enable the source datastore information 210 to interact with the corresponding datastore 110, consistent with the scope of this disclosure.

According to some embodiments, and, as shown, the data connector 109 can also include destination datastore information 212 that corresponds to a datastore 110. According to some embodiments, the destination datastore information 212 can include information similar to the information included in the source datastore information 210. In this regard, the destination datastore information 212 can include information that enables the data connector 109 to programmatically connect to and interact with the datastore 110 to which the destination datastore information 212 corresponds. It should be appreciated that the source datastore information 210 and the destination datastore information 212 can correspond to the same datastore 110 (e.g., in scenarios where the data connector 109 is configured to operate on, migrate, etc., data stored within the datastore 110) or to different datastores 110 (e.g., in scenarios where the data connector 109 is configured migrate information from one datastore 110 to another datastore 110). It should additionally be appreciated that each data connector 109 can include information for additional datastores 110 that are involved in data operations the data connector 109 is configured to perform.

According to some embodiments, and, as shown, the data connector 109 can include data operation logic 214. The data operation logic 214 can include information, executable instructions, etc., for performing one or more data operations on one or more datasets 111 managed by the datastore(s) 110 that correspond to the source datastore information 210 and the destination datastore information 212. The data operation logic 214 can include, for example, transformation rules that dictate how the datasets 111 are to be modified, formatted, etc., during the data operations, such as schema mappings for aligning incompatible data structures, data type conversions to ensure consistency between datastores 110/datasets 111, and normalization processes to standardize the datasets 111 for downstream compatibility. The data operation logic 214 can also include filtering criteria that allow for selective retrieval so that only relevant data is processed. The data operation logic 214 can also include aggregation instructions for combining multiple data elements into unified outputs. The data operation logic 214 can further include enrichment instructions for augmenting datasets 111 with additional attributes.

In additional examples, the data operation logic 214 can define operational workflows that specify the sequence and dependencies of data retrieval, transformation, and delivery tasks to optimize performance and maintain consistency. For instance, the data operation logic 214 can include parallel processing strategies to enhance throughput, conditional logic to dynamically adjust workflows based on dataset 111 properties, runtime conditions, etc., and the like. The data operation logic 214 can also include error-handling protocols that define retry mechanisms for failed data operations, fallback procedures to alternative workflows, and comprehensive logging capabilities to track execution and identify issues for debugging or auditing purposes.

In additional examples, the data operation logic 214 can incorporate security measures to protect sensitive information when performing data operations. Such security measures can include encryption protocols for securing data in transit or at rest, masking or tokenization techniques to obscure sensitive fields, and anonymization rules to comply with privacy regulations. The data operation logic 214 can also include access control configurations to enable data operations to be conducted in accordance with permissions, as well as security policies established for datasets 111, the source datastore 110, the destination datastore 110, and so on.

In further examples, the data operation logic 214 can be configured to implement conflict resolution rules to address inconsistencies between source and destination datasets 110, metadata management to track lineage and changes that take place during data operations, and the like. It is noted that the foregoing examples are not meant to be limiting, and that the data operation logic 214 can include any amount, type, form, etc., of information, at any level of granularity, for effectively performing specific data operations on datasets 111 within one or more datastores 110, consistent with the scope of this disclosure.

According to some embodiments, and, as shown, the data connector 109 can include validation logic 216, which can include information, executable instructions, etc., for verifying the accuracy, integrity, completeness, etc., of information provided in a set of parameters 224, condition information 226, security information 228, and ownership information 230 (described below in greater detail) that is received in conjunction with a request to invoke the data connector 109 to perform requested data operations.

According to some embodiments, the scheduling manager 218 can be configured to orchestrate the execution of different data tasks 112. According to some embodiments, a given data task 112 can correspond to a data connector 109 that has been invoked in response to the data connector manager 202 receiving a request to perform one or more data operations using the data connector 109. In this regard, and, as shown, the data task 112 can include a unique identifier 222 for uniquely identifying the data task 112 relative to other data tasks 112. The data task 112 can also include a unique identifier 206 that references the unique identifier 206 of the data connector 109 to which the data task 112 corresponds.

According to some embodiments, and, as shown, the data task 112 can include different informational components for configuring and managing the execution of data operations via the data connector 109. For example, the parameters 224 can provide information for executing the data operations, including references to source and destination (and/or other) datasets 111, configuration settings such as schema mapping information, format requirements, naming conventions, and other operational specifics. In this regard, the validation logic 216 can be configured to verify that the references to the datasets 111 are accurate, that the datasets 111 exist in their respective datastores 110, and that the datasets 111 comply with any predefined constraints or mappings. The validation logic 216 can also be configured to verify that the configuration settings are properly formatted and compatible with the requested data operations.

According to some embodiments, and, as shown, the data task 112 can also include condition information 226, which defines when and under what circumstances the data task 112 should be executed. The condition information 226 can include timing information such as scheduled intervals or specific dates and times, and/or trigger criteria that are based on data events, such as updates or threshold breaches in the source and/or destination datastores 110, the source and/or destination datasets 111, and the like. In this regard, the validation logic 216 can be configured to check that timing details are properly formatted, do not conflict with other scheduled data tasks 112, and align with the capabilities of the data connector 109. The validation logic 216 can also be configured to verify the validity and feasibility of the trigger criteria to ensure they are properly defined and supported by the datastores 110, the datasets 111, and so on.

According to some embodiments, and, as shown, the data task 112 can also include security information 228, which can include authentication credentials such as usernames, passwords, API keys, token-based access configurations, etc., required to securely access at least one of the relevant datastores 110, datasets 111, the data connector 109, and the like. In this regard, the validation logic 216 can be configured to confirm that the credentials are valid, that the credentials can be used to obtain appropriate authorization for the requested data operations to be performed, and that the credentials conform to any system-wide security protocols, such as encryption or token expiration policies.

According to some embodiments, and, as additionally shown, the data task 112 can include ownership information 230 that identifies the user or entity that requested the generation of the data task 112, the user or entity associated with the dataset(s) 111, and so on. This may include user IDs, roles, metadata, etc., that can be used to effectively link relevant users to the data task 112. In this regard, validation logic 216 can be configured to verify that the ownership information 230 is accurate, to verify that the users have the necessary permissions to perform the requested data operations, and to confirm that the users' roles align with any organizational or policy-based requirements for data ownership and access control.

According to some embodiments, and, as shown, the scheduling manager 218 can be configured to interface with one or more data connector engines 232 to invoke instances of data connectors 109—illustrated in FIG. 2 as data connector instances 234—when data tasks 112 are triggered. In this regard, for a given data task 112, the scheduling manager 218 can configure the corresponding data connector 109 in accordance with the parameters 224, the condition information 226, the security information 228, the ownership information 230, and any other information that is relevant to executing the data connector instance 234 in accordance with the data task 112. In turn, the scheduling manager 218 can cause the data connector engine 232 to execute the data connector 109 in accordance with the applied configurations.

Additionally, and as shown, the scheduling manager 218 can be configured to interface with a registry 236 to generate data task information 238. According to some embodiments, the data task information 238 can provide a comprehensive record of executions of data tasks 112. For example, the information can include, for a given data task 112, execution status information (e.g., pending, in progress, or completed), timestamps of initiation and completion of the execution of the data task 112, information associated with the data connector 109 and the data task 112, and so on. In this manner, the registry 236 can be used to track and log information about data tasks 112 as they are executed, which can be used to effectively facilitate monitoring, auditing, and troubleshooting of current or completed data tasks 112, data connectors 109, and so on. By maintaining this linkage between the scheduling manager 218, the data connector engine 232, and the registry 236, the data connector manager 202 can provide robust coordination and accountability for executing different data operations.

### Data Connector Registration

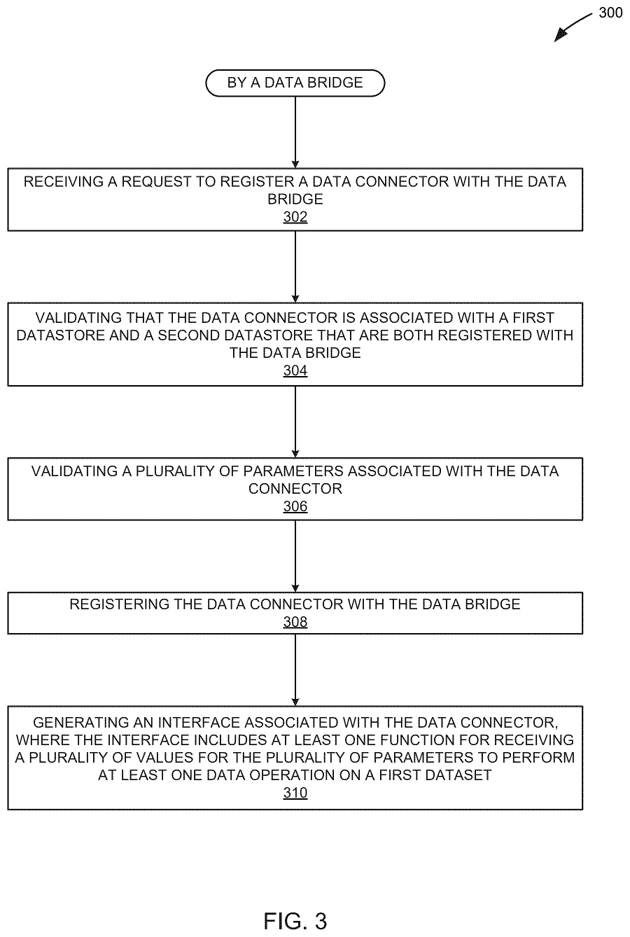

FIG. 3 sets forth a flow diagram of method steps for setting up and implementing one or more data connectors, according to various embodiments. As shown in FIG. 3, a method 300 begins at step 302, where the data bridge 107 receives a request to register a data connector 109 with the data bridge 107. The request can be received, for example, from a software developer operating a developer device 108, and include credentials that are identified by the data bridge 107 as acceptable for processing the request. The request can include at least some of the information included in the data connectors 109 described herein, such as a data connector group identifier 206, a data connector type 208, source datastore information 210, destination datastore information 212, data operation logic 214, and validation logic 216.

At step 304, the data bridge 107 validates that the data connector is associated with a first datastore 110 and a second datastore 110 that are both registered with the data bridge 107. At step 306, the data bridge 107 validates a plurality of parameters associated with the data connector 109. According to some embodiments, to implement steps 304 and 306, the data bridge 107 can implement validation logic that can be used to determine whether the aforementioned information can be used to effectively establish a data connector 109 that adheres to different standards imposed by the data bridge 107. For example, the validation logic can verify that data connector group identifier 206 is already registered with the data bridge 107, or register the data connector group identifier 206 when the data connector group identifier 206 is not already registered with the data bridge 107. In another example, the validation logic can verify that the data connector type 208 corresponds to the source datastore information 210, the destination datastore information 212, and/or the data operation logic 214. In another example, the validation logic can verify that the source datastore information 210 and the destination datastore information 212 refer to datastores 110 that are registered with the data bridge 107, and whether the source datastore information 210 and the destination datastore information 212 include information that is compatible with the respective datastores 110. In yet another example, the validation logic can analyze, execute, etc., the data operation logic 214 to determine whether the data connector 109 effectively performs the data operations that the data connector 109 is designed to perform. It is noted that the foregoing examples are not meant to be limiting, and that the validation logic can implement any number, type, form, etc., of validation check(s), at any level of granularity, when processing a request to register the data connector 109, consistent with the scope of this disclosure.

At step 308, the data bridge 107 registers the data connector 109 with the data bridge 107. According to some embodiments, the data bridge 107 can issue, to the data connector manager 202, a request to register the data connector 109 with the data connector manager 202. In turn, the data connector manager 202 can generate a unique identifier 204 for the data connector 109, and store appropriate information so that the data connector 109 can be invoked within/executed by the data connector engines 232 when data tasks 112 that correspond to the data connector 109 are triggered for execution.

At step 310, the data bridge 107 generates an interface associated with the data connector 109, where the interface includes at least one function for receiving a plurality of values for the plurality of parameters to perform at least one data operation on a first dataset 110. In one example, the interface can be implemented as a graphical user interface (GUI) that includes different user interface elements (e.g., text boxes, dropdowns, etc.) into which parameters for generating a data task 112 associated with the data connector 109 can be provided. In another example, the interface can be implemented as an upload process through which a configuration file that includes the parameters for generating a data task 112 associated with the data connector 109 can be provided. In yet another example, the interface can be implemented as an Application Programming Interface (API) through which the parameters for generating a data task 112 associated with the data connector 109 can be provided. It is noted that the foregoing examples are not meant to be limiting, and that the data bridge 107 can implement any number, type, form, etc., of interface(s), at any level of granularity, to effectively enable users, entities, etc., to provide parameters for generating data tasks 112 associated with the data connector 109, consistent with the scope of this disclosure.

### Data Connector Utilization

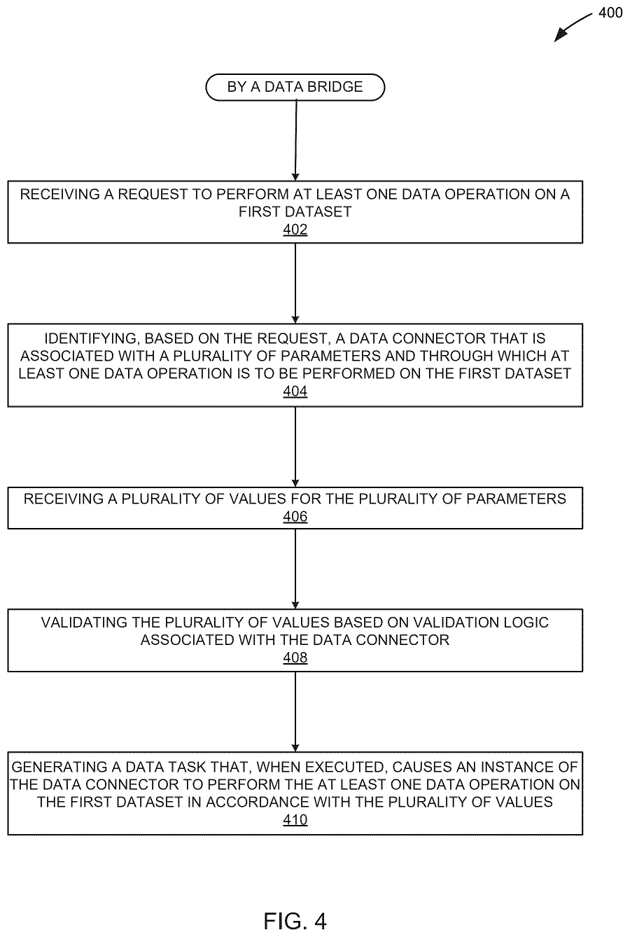

FIG. 4 sets forth a flow diagram of method steps for performing operations on one or more datasets via a data bridge, according to various embodiments. As shown in FIG. 4, a method 400 begins at step 402, where the data bridge 107 receives a request to perform at least one data operation on a first dataset 110. As previously described herein, the request can be received, for example, via a graphical user interface, via a configuration file upload, via one or more API calls, etc., for accessing data connectors 109 registered with the data bridge 107.

At step 404, the data bridge 107 identifies, based on the request, a data connector 109 that is associated with a plurality of parameters (e.g., a data connector type 208, source datastore information 210, destination datastore information 212, data operation logic 214, validation logic 216, etc.) and through which at least one data operation is to be performed on the first dataset 110. According to some embodiments, the aforementioned interfaces can enable users to browse available data connectors 109 and select a particular data connector 109 that they would like to utilize. In this manner, the request can include the unique identifier 204 associated with the data connector 109. The aforementioned interfaces can also enable users to provide information (e.g., one or more datastores 110, one or more datasets 111, etc.) that effectively explains the desired data operations to be performed. In turn, the data bridge 107 can analyze the registered data connectors 109 to determine whether any data connectors 109 are available and suitable for carrying out the desired data operations. In turn, the user can select the data connector 109 that they would like to use, where the request can include the unique identifier 204 associated with the data connector 109.

At step 406, the data bridge 107 receives a plurality of values for the plurality of parameters. The plurality of values can include, for example, values for establishing parameters 224, condition information 226, security information 228, and ownership information 230 for a data task 112 to be generated in association with the request. The plurality of values can be provided by way of one or more of the interfaces described herein. At step 408, the data bridge 107 validates the plurality of values based on validation logic 216 associated with the data connector 109. According to some embodiments, the data bridge 107 can provide indications of failed validations to enable the user to provide corrected values.

At step 410, the data bridge 107 generates a data task 112 that, when executed, causes an instance of the data connector 109 to perform the at least one data operation on the first dataset 110 in accordance with the plurality of values.

### Computing Device Overview

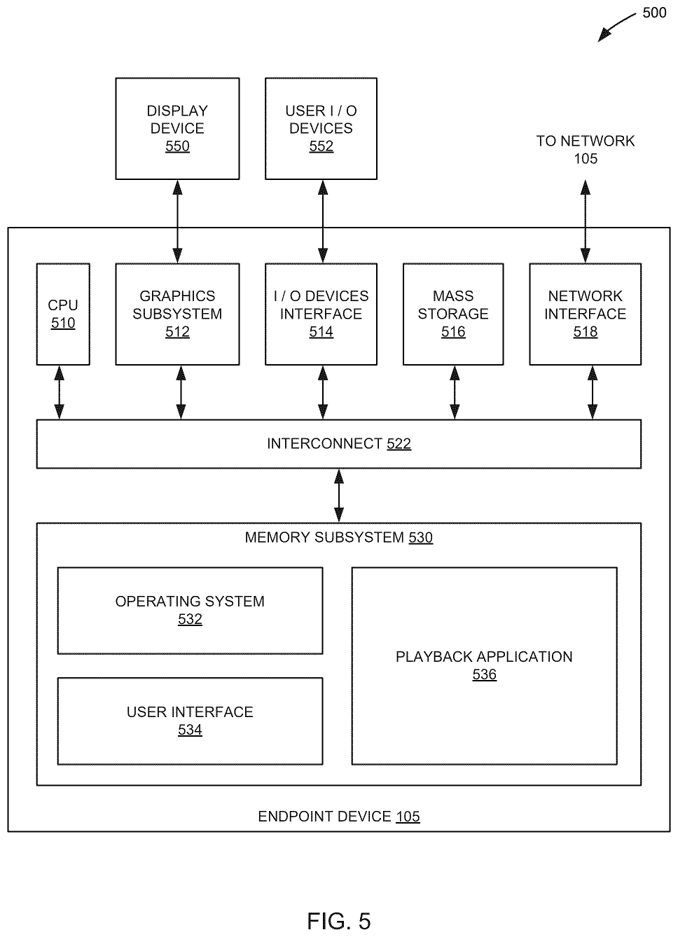

FIG. 5 is a conceptual illustration of a computing device 500 that can be used to implement any of the computing devices shown in FIG. 1, including an endpoint device 102, a server device 106, a developer device 108, and a datastore 110, according to various embodiments. As shown, the computing device 500 can include, without limitation, a CPU 510, a graphics subsystem 512, an I/O device interface 514, a mass storage unit 516, a network interface 518, an interconnect 522, and a memory subsystem 530.

In some embodiments, the CPU 510 is configured to retrieve and execute programming instructions stored in the memory subsystem 530. Similarly, the CPU 510 is configured to store and retrieve application data (e.g., software libraries) residing in the memory subsystem 530. The interconnect 522 is configured to facilitate transmission of data, such as programming instructions and application data, between the CPU 510, graphics subsystem 512, I/O devices interface 514, mass storage 516, network interface 518, and memory subsystem 530.

In some embodiments, the graphics subsystem 512 is configured to generate frames of video data and transmit the frames of video data to display device 550. In some embodiments, the graphics subsystem 512 can be integrated into an integrated circuit, along with the CPU 510. The display device 550 can comprise any technically feasible means for generating an image for display. For example, the display device 550 can be fabricated using liquid crystal display (LCD) technology, cathode-ray technology, and light-emitting diode (LED) display technology. An input/output (I/O) device interface 514 is configured to receive input data from user I/O devices 552 and transmit the input data to the CPU 510 via the interconnect 522. For example, user I/O devices 552 can comprise one of more buttons, a keyboard, and a mouse or other pointing device. The I/O device interface 514 also includes an audio output unit configured to generate an electrical audio output signal. User I/O devices 552 includes a speaker configured to generate an acoustic output in response to the electrical audio output signal. In alternative embodiments, the display device 550 can include the speaker. A television is an example of a device known in the art that can display video frames and generate an acoustic output.

A mass storage unit 516, such as a hard disk drive or flash memory storage drive, is configured to store non-volatile data. A network interface 518 is configured to transmit and receive packets of data via the communications network 104. In some embodiments, the network interface 518 is configured to communicate using the well-known Ethernet standard. The network interface 518 is coupled to the CPU 510 via the interconnect 522.

In some embodiments, the memory subsystem 530 includes programming instructions and application data that comprise an operating system 532, a user interface 534, and a playback application 536. The operating system 532 performs system management functions such as managing hardware devices including the network interface 518, mass storage unit 516, I/O device interface 514, and graphics subsystem 512. The operating system 532 also provides process and memory management models for the user interface 534 and the playback application 536. The user interface 534, such as a window and object metaphor, provides a mechanism for user interactions. Persons skilled in the art will recognize the various operating systems and user interfaces that are well-known in the art and suitable for incorporation into the various devices of FIG. 1.

It will be appreciated that the endpoint device 102, server device 106, developer device 108, and datastore 110 described above in conjunction with FIGS. 1-4 are illustrative, and that variations and modifications are possible. The connection topologies, including the number of CPUs and memories, may be modified as desired, and, in certain embodiments, one or more components shown in FIGS. 1-5 may not be present. Further, in certain embodiments, one or more components shown in FIGS. 1-5 may be implemented as virtualized resources in a virtual computing environment and/or a cloud computing environment.

In sum, the embodiments set forth a comprehensive system for performing data operations across datasets managed by one or more datastores through the use of data connectors. At the core of the system is a data bridge, which sits above and manages the data connectors, a data scheduler, one or more data connector engines, and a registry, which are used to facilitate seamless orchestration and control of the data connectors. The data bridge enables developers to submit, for registration with the data bridge, data connectors that are configured to perform specific data operations on one or more datasets stored in one or more datastores. A given data connector includes data operation logic, which defines different data operations to be performed, and validation logic, which ensures the accuracy, consistency, and security of provided parameters that configure the data connector for execution. A data task is generated when a user requests the use of a data connector, and the data task encapsulates key components such as parameters (e.g., source and destination dataset references, configuration settings, mapping details, etc.), condition information (e.g., timing schedules or event-based triggers), security information (e.g., credentials for accessing datastores and datasets), and ownership information (e.g., identifying the user associated with the task). When a trigger for executing a given data task occurs, the data bridge interfaces with a data connector engine to invoke the corresponding data connector under a configuration that is consistent with the various parameters stored in the data task. Additionally, the scheduling manager interacts with a registry to generate data task information, which can be used to monitor, track, and log the status and execution details of current or completed data tasks.

One technical advantage of the disclosed techniques relative to the prior art is that the disclosed techniques centralize data operations across disparate systems through the use of a data bridge. By acting as a unified coordination point, the data bridge can simplify the flow of data between different systems as well as provide improved error handling and logging capabilities that help identify and address issues that arise when performing data operations. The data bridge includes a registration process that allows developers to contribute data connectors that are designed to handle specific data operations, such as data migrations, with logic tailored to different dataset and datastore types. The modular and scalable framework supports the integration of migration capabilities without requiring extensive redevelopment for each new system or use case. The data bridge also can simplify data migration workflows by allowing users to specify the type of data migration operations to be performed through easy-to-use interfaces. In this regard, the data bridge can identify the appropriate connector for a given data migration task to align the migration logic with the specific requirements of the data migration task. This automated identification can help avoid technical errors that oftentimes occur with conventional, manual approaches, particularly in environments with numerous systems and diverse datasets. Additionally, the data bridge includes scheduling (e.g., predefined times) and conditional execution (e.g., predefined criteria) features that can provide flexibility in performing data operations. These technical advantages provide one or more technological advancements over prior art approaches.

1. In some embodiments, a computer-implemented method for performing operations on datasets via a data bridge comprises receiving a request to perform at least one data operation on a first dataset; identifying, based on the request, a data connector that is associated with a plurality of parameters and through which at least one data operation is to be performed on the first dataset; receiving a plurality of values for the plurality of parameters; validating the plurality of values based on validation logic associated with the data connector; and generating a data task that, when executed, causes an instance of the data connector to perform the at least one data operation on the first dataset in accordance with the plurality of values.

2. The computer-implemented method of clause 1, wherein the first dataset resides within a first datastore, and the at least one data operation comprises generating a second dataset that is based on the first dataset.

3. The computer-implemented method of clause 2, wherein the second dataset is compatible with a second datastore.

4. The computer-implemented method of clause 2, wherein the plurality of values includes at least one of a first identifier associated with the first datastore, a second identifier associated with a second datastore, a first identifier associated with the first dataset, a second identifier associated with the second dataset, security information that includes at least one of first credential information for accessing the first dataset or second credential information for accessing the second dataset, condition information that describes at least one condition under which the at least one data operation is to be executed, mapping information that describes how the second dataset should be generated based on the first dataset, or ownership information that identifies a user who is associated with the request.

5. The computer-implemented method of clause 1, further comprising registering the data task with a scheduling manager that executes the data task when at least one condition is satisfied.

6. The computer-implemented method of clause 5, wherein registering the data task with the scheduling manager comprises assigning, to the data task, ownership information that identifies a user who is associated with the request.

7. The computer-implemented method of clause 5, wherein the at least one condition is satisfied when at least one of an amount of time associated with the data task lapses, a current time aligns with a scheduled time associated with the data task, or at least one change to the first dataset has been made.

8. The computer-implemented method of clause 1, wherein validating the plurality of values based on the validation logic associated with the data connector comprises verifying one or more credentials that are included in the plurality of values and required to perform the at least one data operation.

9. The computer-implemented method of clause 1, further comprising receiving an indication that the data task has been executed; and updating a registry to reflect that the data task has been executed.

10. The computer-implemented method of clause 1, wherein the request and the plurality of values are received via at least one of a user interface, a configuration file, or an Application Programming Interface (API) call.

11. In some embodiments, one or more non-transitory computer readable media store instructions that, when executed by one or more processors, cause the one or more processors to perform operations on datasets via a data bridge, by performing the steps of receiving a request to perform at least one data operation on a first dataset; identifying, based on the request, a data connector that is associated with a plurality of parameters and through which at least one data operation is to be performed on the first dataset; receiving a plurality of values for the plurality of parameters; validating the plurality of values based on validation logic associated with the data connector; and generating a data task that, when executed, causes an instance of the data connector to perform the at least one data operation on the first dataset in accordance with the plurality of values.

12. The one or more non-transitory computer readable media of clause 11, wherein the steps further include assigning a unique identifier to the data task.

13. The one or more non-transitory computer readable media of clause 12, wherein the steps further include: receiving a second request to generate a status report for the data task, wherein the second request includes the unique identifier; and generating the status report based on information associated with an execution of the at least one data operation.

14. The one or more non-transitory computer readable media of clause 11, wherein the data connector is associated with a first unique identifier, and the first unique identifier is assigned to the data task.

15. The one or more non-transitory computer readable media of clause 11, wherein the first dataset resides within a first datastore, and the at least one data operation comprises generating a second dataset that is based on the first dataset.

16. The one or more non-transitory computer readable media of clause 15, wherein the second dataset is compatible with a second datastore.

17. The one or more non-transitory computer readable media of clause 15, wherein the plurality of values includes at least one of a first identifier associated with the first datastore, a second identifier associated with a second datastore, a first identifier associated with the first dataset, a second identifier associated with the second dataset, security information that includes at least one of first credential information for accessing the first dataset or second credential information for accessing the second dataset, condition information that describes at least one condition under which the at least one data operation is to be executed, mapping information that describes how the second dataset should be generated based on the first dataset, or ownership information that identifies a user who is associated with the request.

18. The one or more non-transitory computer readable media of clause 11, further comprising registering the data task with a scheduling manager that executes the data task when at least one condition is satisfied.

19. The one or more non-transitory computer readable media of clause 18, wherein registering the data task with the scheduling manager comprises assigning, to the data task, ownership information that identifies a user who is associated with the request.

20. In some embodiments, a computer system comprises one or more memories that include instructions, and one or more processors that are coupled to the one or more memories and that, when executing the instructions, are configured to perform operations on datasets via a data bridge, by performing the operations of receiving a request to perform at least one data operation on a first dataset; identifying, based on the request, a data connector that is associated with a plurality of parameters and through which at least one data operation is to be performed on the first dataset; receiving a plurality of values for the plurality of parameters; validating the plurality of values based on validation logic associated with the data connector; and generating a data task that, when executed, causes an instance of the data connector to perform the at least one data operation on the first dataset in accordance with the plurality of values.

Any and all combinations of any of the claim elements recited in any of the claims and/or any elements described in this application, in any fashion, fall within the contemplated scope of the present disclosure and protection.

The descriptions of the various embodiments have been presented for purposes of illustration, but are not intended to be exhaustive or limited to the embodiments disclosed. Many modifications and variations will be apparent to those of ordinary skill in the art without departing from the scope and spirit of the described embodiments.

Aspects of the present embodiments may be embodied as a system, method or computer program product. Accordingly, aspects of the present disclosure may take the form of an entirely hardware embodiment, an entirely software embodiment (including firmware, resident software, micro-code, etc.) or an embodiment combining software and hardware aspects that may all generally be referred to herein as a “module,” a “system,” or a “computer.” In addition, any hardware and/or software technique, process, function, component, engine, module, or system described in the present disclosure may be implemented as a circuit or set of circuits. Furthermore, aspects of the present disclosure may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

Aspects of the present disclosure are described above with reference to flowchart illustrations and/or block diagrams of methods, apparatus (systems) and computer program products according to embodiments of the disclosure. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine. The instructions, when executed via the processor of the computer or other programmable data processing apparatus, enable the implementation of the functions/acts specified in the flowchart and/or block diagram block or blocks. Such processors may be, without limitation, general purpose processors, special-purpose processors, application-specific processors, or field-programmable gate arrays.

The flowchart and block diagrams in the figures illustrate the architecture, functionality, and operation of possible implementations of systems, methods and computer program products according to various embodiments of the present disclosure. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The invention has been described above with reference to specific embodiments. Persons of ordinary skill in the art, however, will understand that various modifications and changes may be made thereto without departing from the broader spirit and scope of the invention as set forth in the appended claims. For example, and without limitation, although many of the descriptions herein refer to specific types of I/O devices that may acquire data associated with an object of interest, persons skilled in the art will appreciate that the systems and techniques described herein are applicable to other types of I/O devices. The foregoing description and drawings are, accordingly, to be regarded in an illustrative rather than a restrictive sense.

While the preceding is directed to embodiments of the present disclosure, other and further embodiments of the disclosure may be devised without departing from the basic scope thereof, and the scope thereof is determined by the claims that follow.

What is claimed is:

1. A computer-implemented method for performing operations on datasets via a data bridge, the method comprising:
receiving a request to perform at least one data operation on a first dataset;
identifying, based on the request, a data connector that is associated with a plurality of parameters and through which at least one data operation is to be performed on the first dataset;
receiving a plurality of values for the plurality of parameters;
validating the plurality of values based on validation logic associated with the data connector; and
generating a data task that, when executed, causes an instance of the data connector to perform the at least one data operation on the first dataset in accordance with the plurality of values.

2. The computer-implemented method of claim 1, wherein the first dataset resides within a first datastore, and the at least one data operation comprises generating a second dataset that is based on the first dataset.

3. The computer-implemented method of claim 2, wherein the second dataset is compatible with a second datastore.

4. The computer-implemented method of claim 2, wherein the plurality of values includes at least one of a first identifier associated with the first datastore, a second identifier associated with a second datastore, a first identifier associated with the first dataset, a second identifier associated with the second dataset, security information that includes at least one of first credential information for accessing the first dataset or second credential information for accessing the second dataset, condition information that describes at least one condition under which the at least one data operation is to be executed, mapping information that describes how the second dataset should be generated based on the first dataset, or ownership information that identifies a user who is associated with the request.

5. The computer-implemented method of claim 1, further comprising registering the data task with a scheduling manager that executes the data task when at least one condition is satisfied.

6. The computer-implemented method of claim 5, wherein registering the data task with the scheduling manager comprises assigning, to the data task, ownership information that identifies a user who is associated with the request.

7. The computer-implemented method of claim 5, wherein the at least one condition is satisfied when at least one of an amount of time associated with the data task lapses, a current time aligns with a scheduled time associated with the data task, or at least one change to the first dataset has been made.

8. The computer-implemented method of claim 1, wherein validating the plurality of values based on the validation logic associated with the data connector comprises verifying one or more credentials that are included in the plurality of values and required to perform the at least one data operation.

9. The computer-implemented method of claim 1, further comprising:
receiving an indication that the data task has been executed; and
updating a registry to reflect that the data task has been executed.

10. The computer-implemented method of claim 1, wherein the request and the plurality of values are received via at least one of a user interface, a configuration file, or an Application Programming Interface (API) call.

11. One or more non-transitory computer readable media storing instructions that, when executed by one or more processors, cause the one or more processors to perform operations on datasets via a data bridge, by performing the steps of:
receiving a request to perform at least one data operation on a first dataset;
identifying, based on the request, a data connector that is associated with a plurality of parameters and through which at least one data operation is to be performed on the first dataset;
receiving a plurality of values for the plurality of parameters;
validating the plurality of values based on validation logic associated with the data connector; and
generating a data task that, when executed, causes an instance of the data connector to perform the at least one data operation on the first dataset in accordance with the plurality of values.

12. The one or more non-transitory computer readable media of claim 11, wherein the steps further include assigning a unique identifier to the data task.

13. The one or more non-transitory computer readable media of claim 12, wherein the steps further include:
receiving a second request to generate a status report for the data task, wherein the second request includes the unique identifier; and
generating the status report based on information associated with an execution of the at least one data operation.

14. The one or more non-transitory computer readable media of claim 11, wherein the data connector is associated with a first unique identifier, and the first unique identifier is assigned to the data task.

15. The one or more non-transitory computer readable media of claim 11, wherein the first dataset resides within a first datastore, and the at least one data operation comprises generating a second dataset that is based on the first dataset.

16. The one or more non-transitory computer readable media of claim 15, wherein the second dataset is compatible with a second datastore.

17. The one or more non-transitory computer readable media of claim 15, wherein the plurality of values includes at least one of a first identifier associated with the first datastore, a second identifier associated with a second datastore, a first identifier associated with the first dataset, a second identifier associated with the second dataset, security information that includes at least one of first credential information for accessing the first dataset or second credential information for accessing the second dataset, condition information that describes at least one condition under which the at least one data operation is to be executed, mapping information that describes how the second dataset should be generated based on the first dataset, or ownership information that identifies a user who is associated with the request.

18. The one or more non-transitory computer readable media of claim 11, further comprising registering the data task with a scheduling manager that executes the data task when at least one condition is satisfied.

19. The one or more non-transitory computer readable media of claim 18, wherein registering the data task with the scheduling manager comprises assigning, to the data task, ownership information that identifies a user who is associated with the request.

20. A computer system, comprising:
one or more memories that include instructions; and
one or more processors that are coupled to the one or more memories and, when executing the instructions, are configured to perform operations on datasets via a data bridge, by performing the operations of:
receiving a request to perform at least one data operation on a first dataset;
identifying, based on the request, a data connector that is associated with a plurality of parameters and through which at least one data operation is to be performed on the first dataset;
receiving a plurality of values for the plurality of parameters;
validating the plurality of values based on validation logic associated with the data connector; and
generating a data task that, when executed, causes an instance of the data connector to perform the at least one data operation on the first dataset in accordance with the plurality of values.
